(19) United States
(12) Patent Application Publication
(10) Pub. No.: US 2016/0351053 A1
(43) Pub. Date: Dec. 1, 2016

(54) VEHICLE-TO-VEHICLE BEACON MESSAGE COMMUNICATION SYSTEM AND METHOD

(71) Applicant: MtoV INC., Daejeon (KR)

(72) Inventors: Sangsu JUNG, Uiwang-si (KR); Youngsam KIM, Daejeon (KR); Jongwoo CHOI, Daejeon (KR)

(21) Appl. No.: 14/920,358

(22) Filed: Oct. 22, 2015

(30) Foreign Application Priority Data
May 28, 2015 (KR) 10-2015-0075223

(51) Int. Cl. G08G 1/0967; B60R 1/00; H04N 7/18; G08G 1/09

(52) U.S. Cl. CPC G08G 1/096791; G08G 1/094; B60R 1/00; H04N 7/183

(57) ABSTRACT

Vehicle-to-vehicle beacon message communication system and method are provided. The vehicle-to-vehicle beacon message communication system comprises a photographing unit configured to photograph an image for the surrounding environment of a vehicle, an image processing unit configured to detect first identifying information of a first adjacent vehicle adjacent to the vehicle in the photographed image, a storing unit configured to store the detected first identifying information, a communicating unit configured to receive a beacon message in which second identifying information and running information are included from a second adjacent vehicle adjacent to the vehicle, an information comparing unit configured to compare the second identifying information included in the received beacon message with the stored first identifying information, and, an outputting unit configured to output at least a part of the running information included in the received beacon message in accordance with the comparison result.

### CROSS-REFERENCE TO RELATED APPLICATION

This application claims priority under 35 U.S.C. §119 from Korean Patent Application No. 10-2015-0075223, filed on May 28, 2015 in the Korean Intellectual Property Office, the disclosure of which is incorporated herein by reference in its entirety.

### TECHNICAL FIELD

The embodiments of the present disclosure relate vehicle-to-vehicle beacon message communication system and method which can verify the reliability of beacon message communicated between vehicles.

### RELATED ART

The statements in this section merely provide information related to the present disclosure and do not necessarily constitute prior art.

Intelligent Transportation System (ITS) can provide vehicle safety related application such as cooperative collision warning using Vehicular Ad-hoc Networks (VANETs). In order to provide such safety related application, each vehicle may periodically broadcast the safety massage directly related with the life called beacon in which the state information such as location, velocity, or acceleration is stored to adjacent vehicles. Then, the vehicle can recognize the existence of adjacent vehicle and avoid dangerous situation through the beacon message received from the adjacent vehicle. Since the important information directly related with the human life is included in the beacon message, it would be dangerous if the reliability of the beacon message is not guaranteed.

Beacon message can be communicated between vehicles through electric wave. The strength of electric wave can be easily adjusted by transmitting device, and interference can be generated by surrounding environment, and electric wave has the characteristic of invisibility to the human eye. Therefore, there is the possibility that the beacon message can be forged or altered. In addition, if the accuracy of receiving device is not secured, the vehicle which transmits beacon message may not be identified from the received beacon message.

### SUMMARY

According to the embodiments of the present disclosure, vehicle-to-vehicle beacon message communication system and method which can verify the reliability of beacon messages communicated between vehicles are provided.

In addition, vehicle-to-vehicle beacon message communication system and method which can prevent forging or altering of beacon messages are provided.

Furthermore, vehicle-to-vehicle beacon message communication system and method which can accurately identify the vehicle which transmits beacon message from the received beacon message.

According to the embodiments of the present disclosure, a vehicle-to-vehicle beacon message communication system comprises a photographing unit configured to photograph an image for the surrounding environment of a vehicle, an image processing unit configured to detect first identifying information of a first adjacent vehicle adjacent to the vehicle in the photographed image, a storing unit configured to store the detected first identifying information, a communicating unit configured to receive a beacon message in which second identifying information and running information are included from a second adjacent vehicle adjacent to the vehicle, an information comparing unit configured to compare the second identifying information included in the received beacon message with the stored first identifying information, and, an outputting unit configured to output at least a part of the running information included in the received beacon message in accordance with the comparison result.

According to the embodiments of the present disclosure, a vehicle-to-vehicle beacon message communication method comprises photographing an image for the surrounding environment of a vehicle and detecting first identifying information of the first adjacent vehicle adjacent to the vehicle in the photographed image, storing the detected first identifying information, receiving a beacon message in which second identifying information and running information are included, comparing the second identifying information included in the received beacon message with the stored first identifying information, and, outputting at least a part of the running information included in the received beacon message in accordance with the comparison result.

According to the embodiments of the present disclosure, the reliability of beacon message communicated between vehicles can be verified. In addition, forging or altering of beacon message can be prevented. Furthermore, the vehicle which transmits beacon message can accurately be identified from the received beacon message.

### DESCRIPTION OF THE DRAWINGS

The above and/or other aspects will become apparent and more readily appreciated from the following description of exemplary embodiments, taken in conjunction with the accompanying drawings of which:

FIG. 1 is a diagram illustrating an environment of communicating beacon message between vehicles in accordance with the embodiments.

FIG. 2 is a block diagram illustrating the configuration of a vehicle-to-vehicle beacon message communication system in accordance with the embodiments.

FIG. 3 is a diagram illustrating the output screen in which the running information included in beacon message is displayed in accordance with the embodiments.

FIG. 4 is a flow chart illustrating the step of a vehicle-to-vehicle beacon message communication method in accordance with the embodiments.

### DETAILED DESCRIPTION

Reference will now be made in detail to exemplary embodiments, examples of which are illustrated in the accompanying drawings. However, the present inventive concept may be embodied in many different forms and should not be construed as being limited to the exemplary embodiments set forth herein. Rather, these exemplary embodiments are provided so that the present disclosure will be thorough and complete, and will fully convey the scope of the present inventive concept to those skilled in the art, and the spirit and scope of the present inventive concept should be defined by the appended claims.

Without separate definitions, all terms (including technical and scientific terms) used in the present description may be used for the meanings commonly understandable to those having ordinary skill in the art. In addition, the terms generally used and having definitions in dictionary, unless otherwise defined obviously in particular, should not be ideally or exaggeratedly interpreted.

The terms used in the present description are to explain the exemplary embodiments, not to limit the present invention thereto. In the present description, a singular form of word also includes a plural form thereof unless otherwise noted. The term “comprises” and/or “comprising” is not excluding the meaning that one or more elements other than the said element may exist or be added.

Hereinafter, exemplary embodiments of the present inventive concept will be described in detail with reference to the accompanying drawings. In the drawings, like reference numerals refer to like elements.

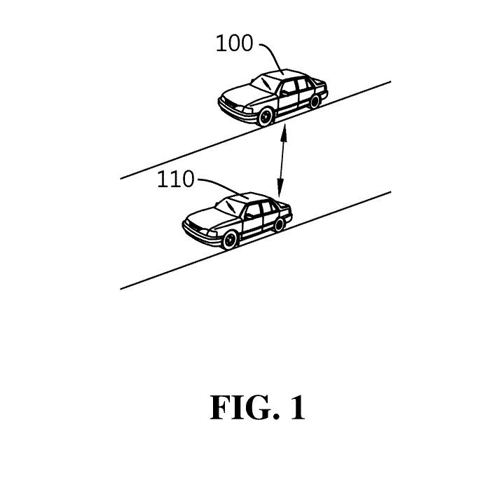

Hereinafter, vehicle-to-vehicle beacon message communication system and method in accordance with the embodiments will be described in detail with reference to FIG. 1 to FIG. 4.

FIG. 1 is a diagram illustrating an environment of communicating beacon message between vehicles in accordance with the embodiments. Referring to FIG. 1, a vehicle-to-vehicle beacon message communication system according to the embodiments may be included in first vehicle 100 or second vehicle 110. The first vehicle 100 or the second vehicle 110 may transmit beacon message to the adjacent vehicles of themselves. In FIG. 1, only two vehicles are illustrated for the convenience, however, if more than three vehicles are existed, each of the vehicles may broadcast the beacon message to the adjacent vehicles. In addition, the first vehicle 100 or the second vehicle 110 may receive the beacon message from the adjacent vehicles.

The beacon message may include identifying information of vehicle and running information of vehicle. The running information of vehicle may include at least one of the state information of vehicle, running information of vehicle, or the state information of vehicle driver. For example, the beacon message may include the vehicle identification number, type of vehicle, location of vehicle, velocity of vehicle, acceleration of vehicle, whether signal lamp is lighted, rotated angle of steering wheel, velocity change information, pressing degree of accelerator, pressing degree of brake, whether hand brake is engaged, the pulse of driver, temperature of driver, blood alcohol concentration of driver, whether drunk driving is conducted by driver, or whether drowsy driving is conducted by driver.

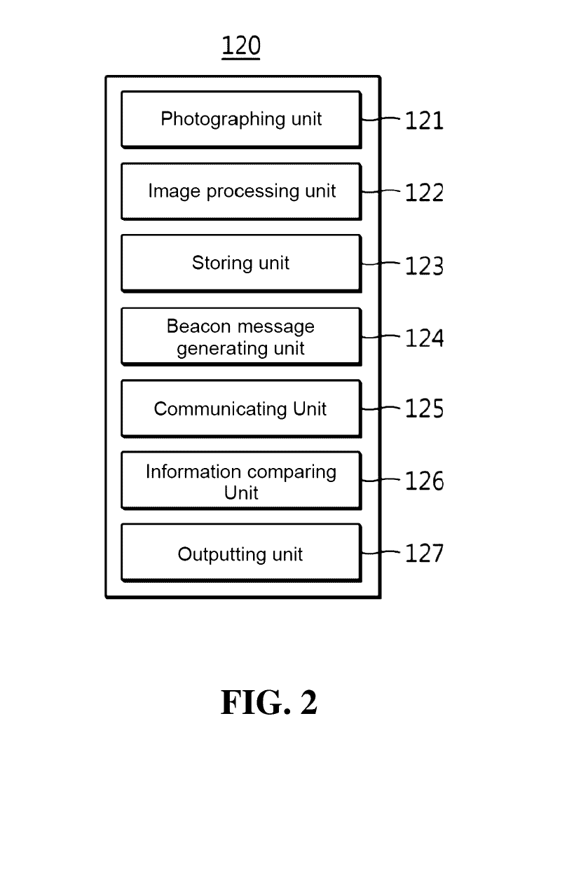

FIG. 2 is a block diagram illustrating the configuration of the vehicle-to-vehicle beacon message communication system in accordance with the embodiments. Referring to FIG. 2, the vehicle-to-vehicle beacon message communication system 120 may comprise photographing unit 121, image processing unit 122, storing unit 123, beacon message generating unit 124, communicating unit 125, information comparing unit 126, and outputting unit 127.

Photographing unit 121 may photograph the surrounding environment of a vehicle. For example, photographing unit 121 may photograph the image of traffic situation at the front of the vehicle. Photographing unit 121 may photograph the image of vehicles adjacent to the vehicle. Photographing unit 121 may be placed at the vehicle. Photographing unit 121 may comprise, for example, camera, infrared camera, depth camera, or stereoscopic camera.

Image processing unit 122 may detect identifying information of vehicles adjacent to the vehicle in the photographed image. The identifying information of the vehicle may be, for example, the vehicle identification number, type of vehicle, or other identifying information. For example, display device may be placed at the outside of the vehicle, and the other identifying information with which the vehicle may be identified such as QR code, text, or figure may be displayed on the display device. Unlike the vehicle identification number or the type of vehicle, QR code, text, or figure may be one-time identifying information which is arbitrarily generated. The arbitrarily generated one-time identifying information can be stronger to forging or altering. Image processing unit 122 may detect the identifying information of the adjacent vehicles by recognizing the license plates of the vehicles, type of vehicle, or other identifying information.

Storing unit 123 may store the detected identifying information. The storing unit 123 may comprise, for example, volatile memory, non-volatile memory, or other storing device.

Beacon message generating unit 124 may generate beacon message. The beacon message generating unit 124 may collect at least one of the identifying information of vehicle, state information of vehicle, running information of vehicle, and the state information of the driver of vehicle. Beacon message generating unit 124 may generate the beacon message using the collected information.

Communicating unit 125 may transmit the generated beacon message to the adjacent vehicle. In addition, the communicating unit 125 may receive the beacon message generated by the adjacent vehicle.

Information comparing unit 126 may compare the identifying information of the adjacent vehicle stored in the storing unit 123 (referred to as the first identifying information hereafter) with the identifying information of the adjacent vehicle which is included in the received beacon message (referred to as the second identifying information hereafter).

According to the comparison result, when the first identifying information corresponding to the second identifying information is not existed among the stored first identifying information, then information comparing unit 126 may judge that the reliability of the beacon message in which the second identifying information was included is low. The beacon message in which the second identifying information was included may be the one forged or altered. In addition, the beacon message in which the second identifying information was included may be the beacon message received from the adjacent vehicle existed at the location out of the view from the vehicle. Therefore, the information comparing unit 126 may disregard the beacon message in which the second identifying information was included.

According to the comparison result, when the first identifying information corresponding to the second identifying information is existed among the first stored identifying information, then information comparing unit 126 may judge that the reliability of the beacon message in which the second identifying information was included is high.

According to the comparison result by the information comparing unit 126, outputting unit 127 may output at least a part of the running information included in the received beacon message. If the reliability of the beacon message is judged to be low by the information comparing unit 126, the outputting unit 127 may not output the running information included in the beacon message. If the reliability of the beacon message is judged to be high by the information comparing unit 126, the outputting unit 127 may output at least a part of the running information included in the beacon message. The outputting unit 127 may comprise, for example, display device, speaker, or other output device. Outputting unit 127 may display the running information included in the beacon message on the display device, or output the guiding voice through the speaker. The outputting unit 127 may display the running information included in the beacon message by overlaying the running information on the image of the surrounding environment photographed by the photographing unit 121.

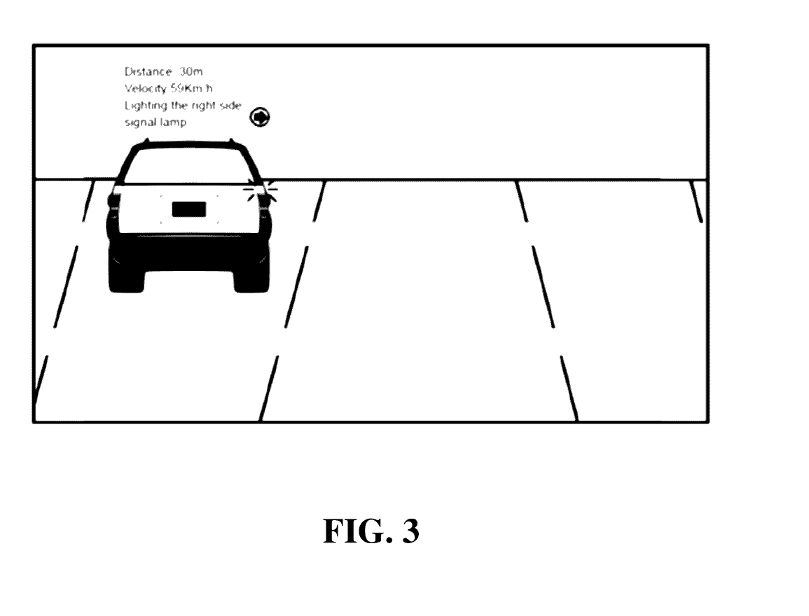

FIG. 3 is a diagram illustrating the output screen in which the running information included in beacon message is displayed by overlaying the running information on the image of the surrounding environment in accordance with the embodiments. Referring to the FIG. 3, outputting unit 127 may display the running information by overlaying it on the image of the adjacent vehicle corresponding to the second identifying information in the image of the surrounding environment photographed by the photographing unit 121.

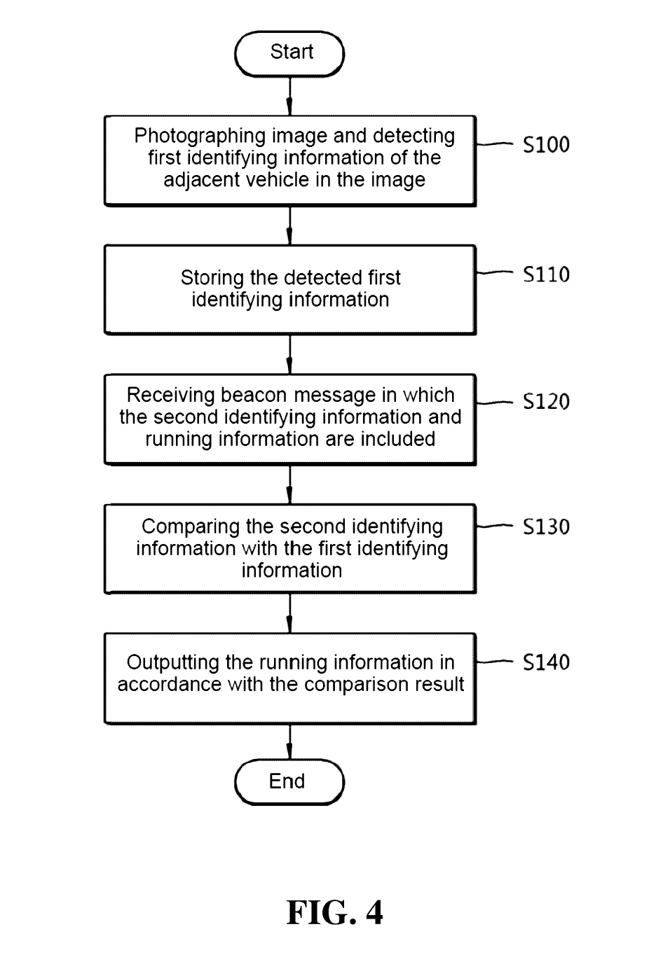

FIG. 4 is a flow chart illustrating the step of a vehicle-to-vehicle beacon message communication method in accordance with the embodiments. Referring to FIG. 4, step S100 of photographing an image for the surrounding environment of the vehicle and detecting the first identifying information of the adjacent vehicle adjacent to the vehicle in the photographed image may be performed. Photographing unit 121 can photograph the image of the surrounding environment of the vehicle. Image processing unit 122 may detect the first identifying information of the adjacent vehicle in the photographed image.

In the next sequence, stage S110 of storing the detected first identifying information may be performed. Storing unit 123 may store the detected first identifying information.

In the next sequence, the stage S120 of receiving the beacon message in which the second identifying information and running information are included may be performed. The beacon message generating unit 124 of the adjacent vehicle may generate and transmit the beacon message which includes the second identifying information corresponding to the adjacent vehicle. Communicating unit 125 may receive the beacon message from the adjacent vehicle. The communicating unit 125 may receive the beacon message from the adjacent vehicle corresponding to the first above identifying information or receive the beacon message from the adjacent vehicle not corresponding to the first above identifying information.

In the next sequence, the stage S130 of comparing the second identifying information included in the received beacon message with the stored first identifying information may be performed. Information comparing unit 126 may compare the first identifying information with the second identifying information.

In the next sequence, according to the comparison result, the stage S140 of outputting at least a part of the running information included in the received beacon message may be performed. If the reliability of the beacon message is judged to be low by the information comparing unit 126, the outputting unit 127 may not output the running information included in the beacon message. If the reliability of the beacon message is judged to be high by the information comparing unit 126, the outputting unit 127 may output at least a part of the running information included in the beacon message.

According to the embodiments described hereinbefore, the reliability of the beacon message communicated between vehicles can be verified. In addition, forging or altering of beacon message can be prevented. Furthermore, the vehicle which transmits beacon message can accurately be identified from the received beacon message.

While exemplary embodiments have been particularly shown and described, it will be understood by those of ordinary skill in the art that various changes in form and details may be made therein without departing from the spirit and scope of the present inventive concept as defined by the following claims.

What is claimed is:

1. A vehicle-to-vehicle beacon message communication system comprising:
a photographing unit configured to photograph an image for the surrounding environment of a vehicle;
an image processing unit configured to detect first identifying information of a first adjacent vehicle adjacent to the vehicle in the photographed image;
a storing unit configured to store the detected first identifying information;
a communicating unit configured to receive a beacon message in which second identifying information and running information are included from a second adjacent vehicle adjacent to the vehicle;
an information comparing unit configured to compare the second identifying information included in the received beacon message with the stored first identifying information; and,
an outputting unit configured to output at least a part of the running information included in the received beacon message in accordance with the comparison result.

2. The vehicle-to-vehicle beacon message communication system according to claim 1, wherein the first identifying information is the vehicle identification number, type of vehicle, QR code, text or figure.

3. The vehicle-to-vehicle beacon message communication system according to claim 1, wherein the running information includes at least one of the state information of the second adjacent vehicle, running information of the second adjacent vehicle and the state information of the driver of the second adjacent vehicle.

4. The vehicle-to-vehicle beacon message communication system according to claim 1, wherein the running information includes at least one of the location, velocity, acceleration of the second adjacent vehicle, whether signal lamp is lighted, rotated angle of steering wheel, velocity change information, pressing degree of accelerator, pressing degree of brake, whether hand brake is engaged, the pulse, temperature, and blood alcohol concentration of the driver of the second adjacent vehicle, whether drunk driving is conducted, or whether drowsy driving is conducted.

5. The vehicle-to-vehicle beacon message communication system according to claim 1, wherein the outputting unit outputs at least a part of the running information by overlaying at least a part of the running information to the part corresponding to the second adjacent vehicle in the photographed image, when the first identifying information corresponding to the second identifying information among the stored first identifying information is existed.

6. The vehicle-to-vehicle beacon message communication system according to claim 1, further comprises a beacon message generating unit configured to generate a beacon message for the vehicle, and wherein the communicating unit broadcasts the generated beacon message.

7. A vehicle-to-vehicle beacon message communication method comprising:
photographing an image for the surrounding environment of a vehicle and detecting the first identifying information of the first adjacent vehicle adjacent to the vehicle in the photographed image;
storing the detected first identifying information;
receiving a beacon message in which second identifying information and running information are included;
comparing the second identifying information included in the received beacon message with the stored first identifying information; and,
outputting at least a part of the running information included in the received beacon message in accordance with the comparison result.

8. The vehicle-to-vehicle beacon message communication method according to claim 7, wherein the outputting at least a part of the running information included in the received beacon message in accordance with the comparison result comprises outputting at least a part of the running information, when the first identifying information corresponding to the second identifying information among the stored first identifying information is existed.
